(19) United States
(12) Patent Application Publication
(10) Pub. No.: US 2026/0059325 A1
(43) Pub. Date: Feb. 26, 2026

(54) SYSTEM AND METHOD FOR CLIENT DEVICE TAMPERING DETECTION

(71) Applicant: LOCANCE, INC., Carlsbad, CA (US)

(72) Inventors: Mario Proietti, Fullerton, CA (US); Masoud Motamedi, Woodland Hills, CA (US); Csaba Jére, Odorheiu Secuiesc (RO); William J. Matzenger, Midland, TX (US); Alex C. Rosekrans, Concord, NC (US)

(21) Appl. No.: 19/249,707

(22) Filed: Jun. 25, 2025

Related U.S. Application Data
(60) Provisional application No. 63/686,683, filed on Aug. 23, 2024.

(51) Int. Cl. H04W 12/63; H04W 12/06; H04W 64/00

(52) U.S. Cl. CPC H04W 12/63; H04W 12/06; H04W 64/003

(57) ABSTRACT

System and method for client device tampering detection includes: obtaining, from a client device, location data; configuring a location compliance profile specifying a combination of one or more environmental data types; forming a fingerprint combining one or more expected location data values based on the location compliance profile; analyzing the location data against the fingerprint specifying one or more expected location data values based on the location compliance profile; identifying an indication of location tampering based on the analyzing; and indicating that the client device location is confirmed or not confirmed, based on the analyzing.

### CROSS-REFERENCE TO RELATED APPLICATIONS

This Patent application claims the benefits of U.S. Provisional Patent Application Ser. No. 63/686,683, filed on Aug. 23, 2024, and entitled “Client Device Tampering Detection,” the entire content of which is hereby expressly incorporated by reference.

### FIELD

The present disclosure relates generally to the field of software and electronic devices. More specifically, the present disclosure pertains to a system and method for device tamper detection for online security.

### BACKGROUND

Accurate and reliable evaluation of client devices is important in many contexts such as online transaction processing. For example, some online transactions require characteristics of a request of a client device to be verified before processing for compliance with requirements placed on the transaction processor, such as confirming a client device is trustworthy. Contexts in which transaction processors are subject to such requirements include, but are not limited to, online gaming and various “know-your-customer” standards.

Evaluating client devices in a timely manner is technically complex, for example, because there are a variety of device types, sensor types, and data types used to make such determinations. Having gathered data regarding a client device, various methods are used to analyze the data and make a determination. There are also a variety of known and continually evolving countermeasures used to falsify or spoof client device data, making client device communications to a transaction processor less trustworthy.

### BRIEF SUMMARY

In some embodiments, the present disclosure is directed to a method for authenticating a location of a device including: obtaining, from a client device, location data; configuring a location compliance profile specifying a combination of one or more environmental data types; forming, using a set of one or more processors, a fingerprint combining one or more expected location data values based on the location compliance profile; analyzing, using the set of one or more processors, the location data against the fingerprint specifying one or more expected location data values based on the location compliance profile; identifying an indication of location tampering based on the analyzing; and indicating, based on the analyzing, whether the client device location is confirmed or not.

In some embodiments, the present disclosure is directed to a system, including: a set of one or more processors; and a non-transitory storage medium comprising code executable by the one or more processors and being configurable to: obtain, from a client device, location data; configure a location compliance profile specifying a combination of one or more environmental data types; form a fingerprint combining one or more expected location data values based on the location compliance profile; analyze the location data against the fingerprint specifying one or more expected location data values based on the location compliance profile; identify an indication of location tampering based on the analyzing; and indicate, based on the analyzing, that the client device location is not confirmed.

### BRIEF DESCRIPTION OF DRAWINGS

A more complete appreciation of the disclosure, and many of the attendant features and aspects thereof, will become more readily apparent as the disclosure becomes better understood by reference to the following detailed description when considered in conjunction with the accompanying drawings in which like reference symbols indicate like components.

FIG. 1 illustrates an exemplary process for detection of location tampering, according to some embodiments of the present disclosure.

FIG. 2 depicts an exemplary configuration user interface (UI), according to some embodiments of the present disclosure.

FIG. 3 shows an exemplary configuration UI, according to some embodiments of the present disclosure.

FIG. 4 and FIG. 4A illustrate an exemplary client device and associated web browser, according to some embodiments of the present disclosure.

FIG. 5 illustrates an exemplary process for indication of client software compliance, according to some embodiments of the present disclosure.

FIG. 6 shows an exemplary process for indication of client software compliance using an SDK, according to some embodiments of the present disclosure.

FIG. 7 illustrates an exemplary process for indication of client browser compliance, according to some embodiments of the present disclosure.

FIG. 8 illustrates an exemplary workflow editor device, according to some embodiments of the present disclosure.

FIG. 9 illustrates an exemplary process for a workflow editor, according to some embodiments of the present disclosure.

FIG. 10 depicts an exemplary system, according to some embodiments of the present disclosure.

### DETAILED DESCRIPTION

Some embodiments of the present disclosure are directed to system and method of configuration interfaces and techniques for analyzing location data, including but not limited to environmental and historical data, to determine location tampering as part of an online transaction processing workflow. When a location of a client device is requested, the system permits a location determination decision or compliance check to be made by considering a likelihood that location data has been tampered with or modified. In some examples, environmental data analysis is used to compute a likelihood of the tampering or modification.

In some embodiments, the environmental data analysis includes comparison of sensed data with provided or generated sensed data. In one example, provided sensed data is reported by other client devices in a known location that are proximate to the purported location of the client device. In other examples, the provided or generated sensed data may be reported by third-party sources or computed or calculated directly, for example using a known relationship between sensor data and location. In some examples, historical data analysis is used to compute the likelihood, using data indicative of location history or modification thereof, directly or indirectly, with respect to current location data received from the client device. In various embodiments, a combination of likelihoods may be utilized, including applying rules-based analysis of location data received from a client device. In some embodiments, detection of device, location, or operating system tampering (e.g., in the form of jailbreak or root-user tampering) may be used as part of compliance or tampering processing, including production of one or more indications regarding the same.

Some embodiments provide for use and analysis of location data. Location data may include one or more of data indicative of geolocation and data indicative of relative location, for example, with respect to a structure or landmark such as a building, physical gaming space, room, etc. Therefore, unless otherwise specified, embodiments described in connection with geolocation data may be adapted and applied to embodiments operating in a location determination setting in which it is determined whether a requesting user device is located at or near a building, room, etc.

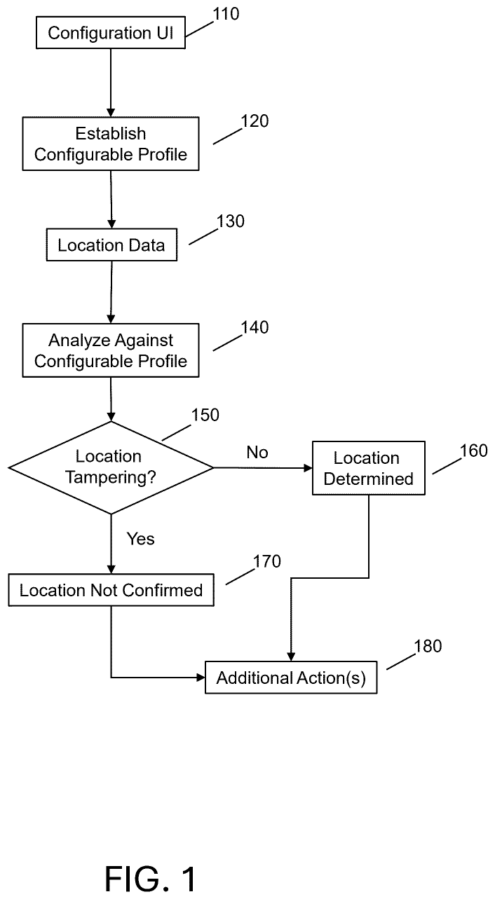

FIG. 1 illustrates an exemplary process for detection of location tampering, according to some embodiments of the present disclosure. As shown, the location tampering detection is configured and used as part of a transaction processing workflow responding to a client device request. In block 110, an administration (admin) user may interact with a configuration UI, using a server of a compliance checking service, to generate a profile used for a compliance check. In block 120, an admin user makes selections to create a profile comprising a set of data and/or rule(s) used to evaluate a request of a client device, using a configuration UI.

Thereafter, when a client device makes a request, for example to perform an online transaction, location data is obtained, as illustrated in block 130. The location data may be obtained from the client device, a set of community devices, a third-party service, or a combination thereof. In block 140, the location data is analyzed against a selected configurable profile prepared using the configuration UI. As further described herein, the analysis of the location data may use environmental data, the format of the location data, the presence or absence of supplemental location details such as speed, altitude, accuracy and the like, comparison to historical data, or a combination of the foregoing.

The analysis of the location data enables a determination in block 150 as to whether potential location tampering is indicated, for example, the location data received in block 130 does not conform to a selected profile as further described herein. Outputs of the determination may include, for example, a confidence level, a binary decision, a location estimate for the client device, or the like. For example, environmental data such as barometric pressure values may be reported by a group of devices of known location and used for generation of statistics such as mean and standard deviation against which location data of the client is compared, with a confidence level assignment resulting from a determination that the client data falls within or outside of a numerical range.

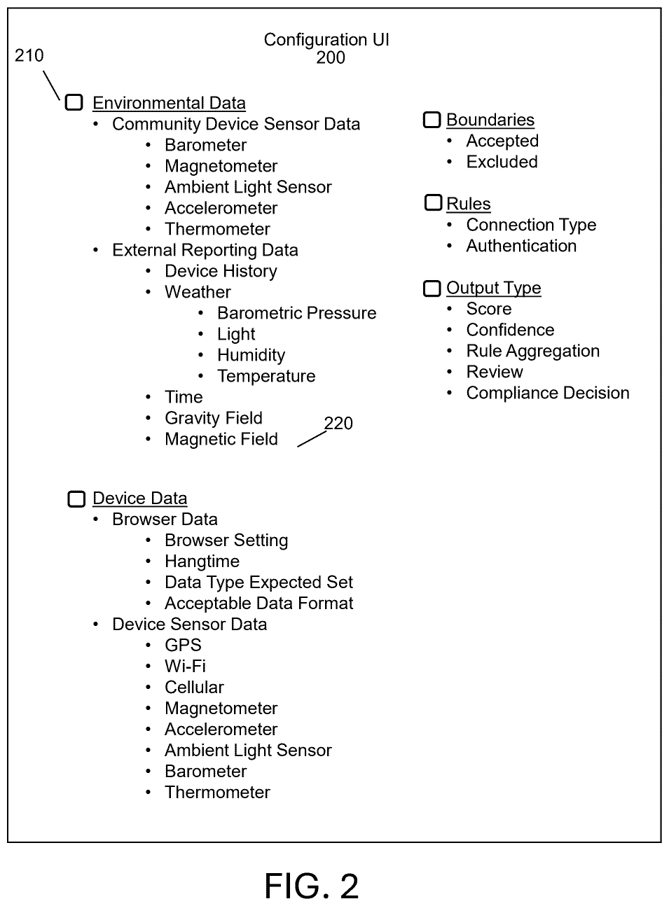

By way of specific example, a client device's data that is within one standard deviation of the mean of a group of device's environmental data, such as barometric pressure, may be scored with a higher confidence level, e.g., an arbitrarily assigned numeric value or category, such as “high,” as compared to a client device's data falling outside of this range. In some embodiments, output of the determination in block 150 includes a list of one or more coded or uncoded values which reference elements from a configuration UI (e.g., as shown in FIG. 2) to provide information about possible location tampering attempts. In some embodiments, output of the determination includes data used to estimate confidence, decision, location validity, etc. For example, one of predetermined several locations may be selected as representing the most-likely location, for example a weighted sum of confidence values for environmental data and/or location data may be used.

Responsive to a lack of indication of location tampering determined in block 150, the location may be determined and confirmed in block 160, for example, the location may be reported with high confidence, representing degree of confirmation. Responsive to an indication of potential location tampering in block 150, the location, for example claimed by the client device, may not be confirmed, reported low confidence, as shown in block 170. The output in block 170 may include a confidence score, a binary decision, an estimated location, etc. In some embodiments, one or more additional actions may be performed as indicated in block 180, such as combining the output with additional factors, progressing to the next step in a workflow, etc., as further described below.

FIG. 2 depicts an exemplary configuration user interface (UI), according to some embodiments of the present disclosure. As shown, a configuration UI 200 is displayed to an admin user. Configuration UI 200 may include a variety of interactive display elements that permit an admin user to review and define the data and rule set to be used as part of a compliance check for a requesting client device, for example defining a profile of expected location data with which the location data of the client will be compared to detect location tampering. While configuration UI 200 may take a variety of forms, the example of FIG. 2 illustrates some examples of types of interactive elements that may be utilized to configure a compliance check profile.

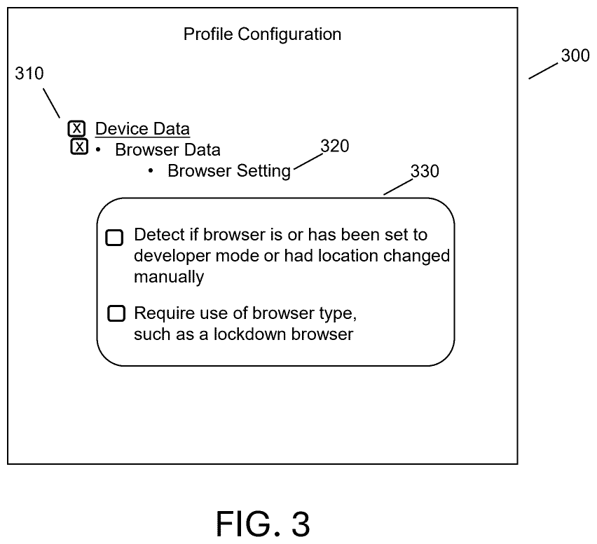

In some embodiments, configuration UI 200 includes interactive elements that are grouped into logical categories, for example including but not limited to environmental data, device data, boundaries, rules, and output type. An admin user may interface with the interactive elements in a variety of ways to select options included or excluded from a compliance check profile. For example, a user may interface with an interactive element 210 to select a category or subcategory for inclusion or exclusion in the process. Similarly, the interactive elements, such as indicated at 220, may be linked to submenus or modals that display additional information and further profile settings, as further described in connection with FIG. 3.

Each category in configuration UI may include one or more subcategories or interactive options, for example, community device sensor data options may be provided in an environmental data group, allowing an admin user to select among device sensor data types to be used, such as magnetometer, accelerometer, barometer, ambient light sensor, altitude or elevation, temperature, humidity, ambient sound/noise samples, etc. Similarly, device history, weather (e.g., barometric pressure, light, etc.), time, gravity field, and magnetic field data types may be included in an external reporting category, for example reported by a third-party service offering data indicated for a geographic area associated with the claimed location of a requesting client device. It is noted that some or all of the options in the external reporting data category may be similarly available from a community of client devices, as further described herein.

An admin user may utilize the configuration UI to select device data of the requesting client device to be used in the processing of a request. The configuration or selection of device data may also be done programmatically, in whole or in part, for example based on historical data, current data or trends using pre-programmed rules and/or application of machine learning methods to automatically generate suggested configuration settings such as those available for manual configuration in configuration UI. Such settings may be based on the perceived risk factors resulting from potential tampering or the safety margin required by the confirmation process for a particular application.

In some embodiment, configuration UI may include interactive elements for use of device data including browser data, such as browser setting 220, event hangtime, expected data type, presence or absence of particular data, and acceptable data format. Device sensor data of the requesting client may also be utilized, for example interactive elements are provided in configuration UI for use of GPS, Wi-Fi, or other conventional location data types such as triangulation from cell towers or cellular data, etc. Selections available in configuration UI may include device sensor data from the client device collected from additional, unconventional sensors such as an accelerometer, an ambient light sensor, a magnetometer, and a barometer. In some embodiments, an admin user may configure a rule to compare various sensor data of one or more client device or device type with that of a community of devices, a third-party source, or a combination.

In some embodiment, configuration UI may be customized to meet various needs, such as allowed and excluded locations. This may involve provision of presets or templates that facilitate presetting a group of user selections of options, rules, etc., known to be useful for the type of compliance check profile being created. Such a template may be used in implementing a predefined workflow component having configuration data values or parameters pre-filled, as described further herein. For example, in some embodiments configuration UI 20 may include selections for including boundaries used by a given transaction processor, such as geographic boundaries of municipalities, states, nations, etc.

Further, configuration UI may be used to define boundaries in a customized manner, for example via defining a boundary using an interactive map feature to include or exclude an allowed or disallowed area. In some embodiment, a user may be presented with a customizable template that has preset or default choices, selecting boundaries associated with absolute compliance requirements, for example state requirements, etc., that may be adjusted through manual input if needed. Once adjusted, the template may be saved for use by others.

Referring to FIG. 2, in addition to included and excluded boundaries, some embodiments may be configured to use an estimated distance to an allowed or excluded boundary or landmark. The distance estimation in conjunction with the device location accuracy, speed and direction of travel, can be used to assess likelihood of compliance, reported using a confidence or probability of an acceptable or non-acceptable location in relation to the boundary. For example, a distance estimation for a client device to a boundary, such as a state line, may be formed using location data, e.g., GPS data. The distance estimation may be updated over time, showing a change in location per unit time along with a direction of travel.

This collection of data may be used to establish a likelihood of compliance, e.g., a device located many miles from a state line and traveling at a low rate of speed, e.g., walking, may be scored with a higher level of confidence for compliance, e.g., using a numerical value or category, than a client device located closer to the boundary and travelling at a higher rate of speed towards the boundary. In another embodiment, device dynamics can be used to determine a duration at which the location information may be deemed acceptable. For example, if a client device is estimated to be far from a boundary and moving slowly, a longer duration for compliance may be allowed, and vice versa.

Some embodiments may use historical data about a client device's location, device attributes (e.g. Samsung™ or Apple™), or software attributes (e.g., operating system or browser version) with device motion to compare with current data values to estimate compliance or non-compliance expiration times, and likely future compliance status. In some embodiments, such estimation may be performed using machine learning methods in which models are trained to categorize data values and estimate values for each category.

In some embodiments, configuration UI also allows for multiple, and related, regions to be defined, including buffer zones around a region. Within a buffer zone, ranges of distance from the boundary may be used to set different criteria for expiration times, speed assessments and location accuracy acceptance. By applying more than one buffer zone to a region, complex rules determining compliance may be achieved using the simplicity of configuration UI.

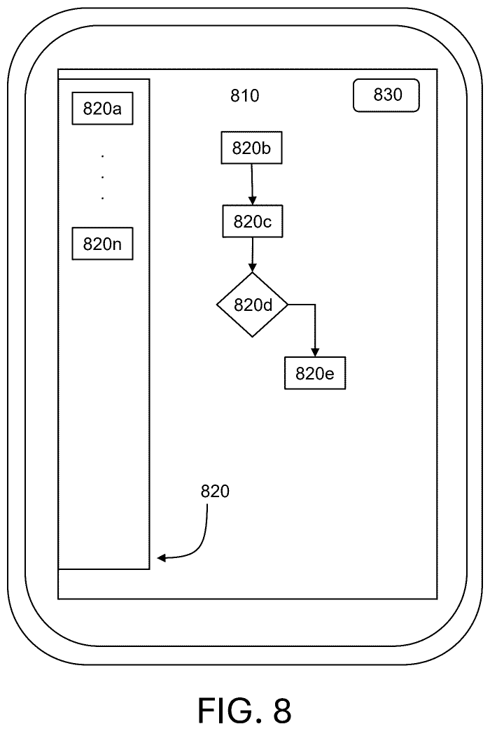

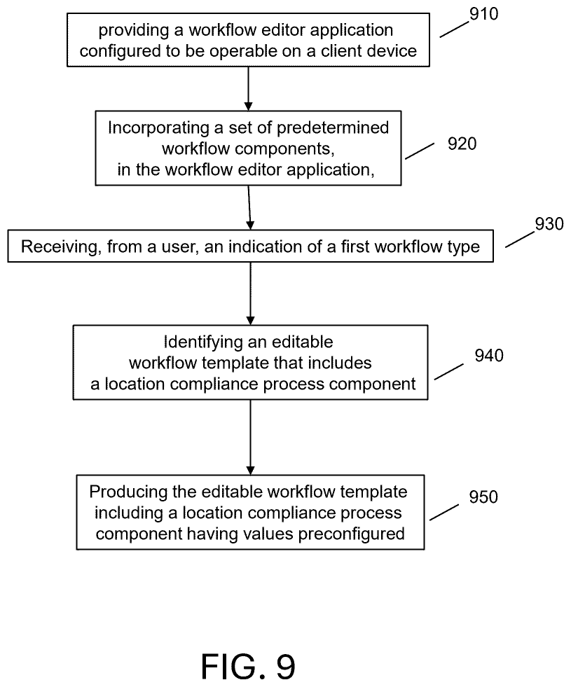

In some embodiments, rules may be formed and implemented in configuration UI 200. In the example of FIG. 2, the rules may be selected, manually or from a default set, for example, a required connection type for the requesting client, such as wired or mobile, a required authentication type used by the requesting client, such as multi-factor authentication or use of a lockdown browser, etc. In some embodiments, configuration UI may be used to define a rule set, for example, using a low code environment in a flow or logic canvas or configuring sequential actions to be followed during processing of a request from a client device, as further described in connection with FIGS. 8 and 9. For instance, reset templates of rule flows may be provided, which are customizable via user interaction with a rule configuration canvas provided by or in connection with configuration UI 200.

In some embodiments, configuration UI may be utilized as part of defining a location compliance workflow, to specify an output type, for example acceptable to the transaction processor. By way of example, configuration UI may include an option for selecting a score output, for example on a predetermined scale acceptable to a transaction processor application. Also, a user may select a rule for aggregating several outputs, such as scores from different categories of evaluation or comparison to community devices, third-party reported data, etc., each of which may be weighted differently.

Further, an admin user may specify a requirement for triggering a review action, for example as part of a workflow. An admin user may specify a compliance decision, such as a binary decision, an estimate of the location of a client device, etc. All output type selections may be considered as informing additional actions, for instance, as indicated in block 180 of FIG. 1. For example, combining a confidence score output type and a review output type may indicate the client device is suspected of not being located within an acceptable location, triggering a need for manual review or additional data collection.

FIG. 3 shows an exemplary configuration UI, according to some embodiments of the present disclosure. Configuration UI 300 may include various views for establishing device data 310, the data types and the processing to be applied to requests of a client device. As shown, an admin user has interacted with a browser setting option (e.g., element 220 of FIG. 2) for browser setting and is presented with configuration UI 300, indicating that browser setting 320 is in focus, with additional interactive options in a modal 330. As illustrated, an admin user may select from further options in modal 330 for evaluating browser data of the requesting client device.

For example, an admin user may select that the browser running on a client device is analyzed to determine if the browser has been configured suspiciously. For example, the browser being in developer mode, the browser having had a location changed within a predetermined time period, or delay in location reporting, such as after start of a location determination script (collectively unacceptable “hangtime”), or having had a location input manually, are all indicative that location tampering is suspected. As further described herein, some anomalies may be categorized as “known” tampering, which may be used alone or in combination with location tampering detection in an embodiment. For example, device tampering in the form of rooting or jailbreaking is a common technique which, when detected, may be used to inform other potential tampering detection techniques, such as increasing the required level of compliance for a location.

In some embodiment, configuration UI 300 may be used to select from options 330 a setting that specifies that a particular browser type or version is required, for example only client devices that issue requests from a specified browser type, such as a lockdown browser, will be accepted.

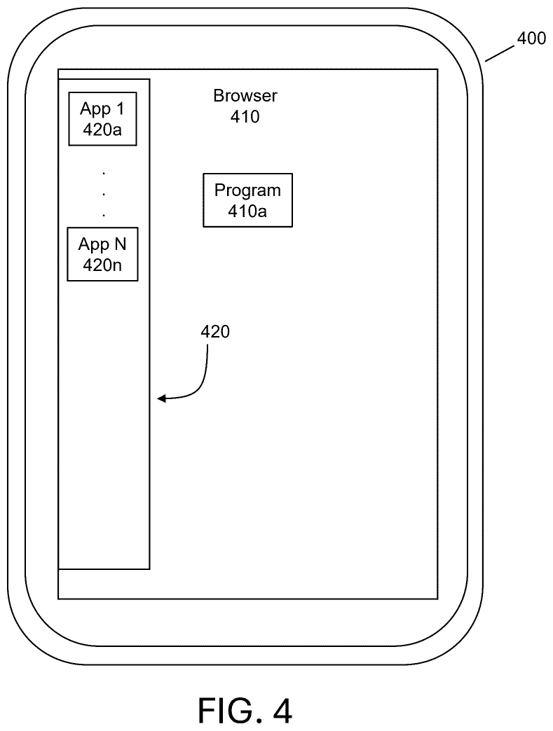

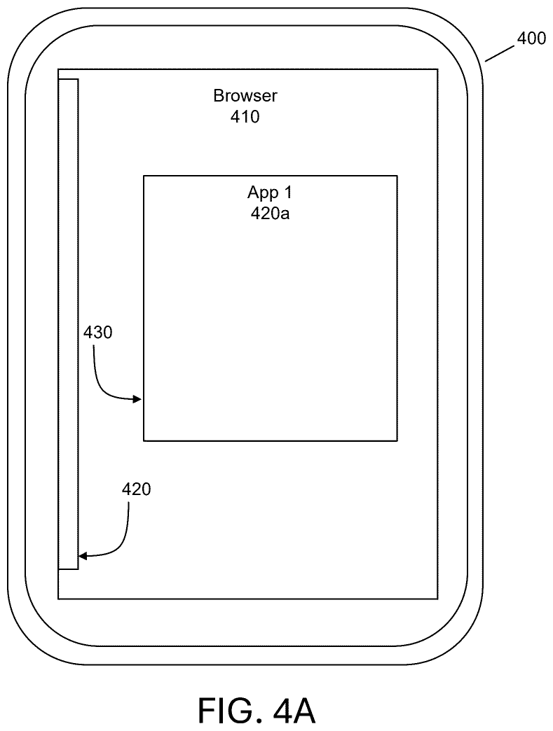

FIG. 4 and FIG. 4A illustrate an exemplary client device and associated web browser, according to some embodiments of the present disclosure. As depicted, a client device 400 includes a browser 410 having a browser program 410a. Browser 410 may be of a specific type, for example, a lockdown browser in which browser 410 has certain functionality locked down, i.e., protected, inaccessible, or unavailable. By way of specific, non-limiting example, a lockdown browser may be provided with a developer mode, or similar, that is typically accessible to change location manually, that cannot be accessed without an authorization token. This may be useful, for example, in adding a guarantee that manual location values cannot be set. Guarantees such as this allow community data from a group of proximal client devices to be used with more confidence if at least one has the guarantee. For example, a configuration user, e.g., via configuration UI 300, may require that a lockdown browser be utilized such that the configuration user's service, such as a compliance checking service, is made aware of access requests and access to browser functionality associated with location tampering.

In some embodiments, the compliance checking service may control and issue authorization tokens, such as a JSON web token (JWT) that includes claims for the authorized user and signature of the authenticating service, permitting the user in possession of the token access to service(s), such as accessing protected browser functionality. In some embodiments, a third-party service may issue the authorization tokens, for example, an identity and access management service, which may provide additional reporting data as part of the compliance checking service.

In some embodiments, browser 410 is provided as a lockdown browser without functionality associated with location or other tampering. For example, browser 410 may be provided without a developer mode, precluding any possibility that an end user of client device 400 has tampered with the browser location. Other examples of a lockdown browser include, but are not limited to, a browser or program without editable header fields, fonts, languages, etc., without a private or incognito mode (or one that only allows masking non-essential functions) or that does not allow use of a proxy service, etc.

In some embodiments, browser 410 may be a lockdown browser that lists associated services that may be used via the lockdown browser. For example, lockdown browser may list or display links to various services, such as online gaming services, that accept the lockdown browser as being required for location tampering detection and compliance. In this manner, an embodiment provides a lockdown browser that has various predetermined integrations, for example integration with online gaming services such that these are displayed in a panel or sidebar and selectable for directly navigating to common or popular online gaming sites, facilitating convenient user ID workflows, location determination workflows, etc., for use of such services accessed in a streamlined manner from the lockdown browser or application.

As described herein, use of a lockdown browser or application facilitates confidence on the part of transaction processors, such as online gaming services, allowing such to proceed with transaction processing for users of lockdown browsers or applications knowing that various features are not available, such as modification of location related data, message parts (e.g., headers), fonts, etc.

In some embodiments, a software development kit (SDK) permits developers of online or mobile gaming services to produce applications that work with a lockdown browser or application. For example, the SDK may provide application programming interfaces (APIs) and resources for developers to integrate with a lockdown browser, allowing the online gaming service or mobile application to be integrated or featured in the lockdown browser, for example presented in a gallery view or sidebar, as well as allowing the online gaming service to interact with the lockdown browser or application for location determination services and related workflows, such as user identification workflows.

In some embodiments, lockdown browsers or applications that are more immune to location tampering may be provided in a virtual marketplace so that users can easily find and install the correct software. In some embodiments, certain online applications, such as games, may be designated as compatible with available lockdown browsers or applications, for example, when a user is browsing a game application store, each compatible application can include an icon that indicates it is “location safe” or similar. In some embodiments, an application may automatically install a lockdown browser, application or code before a location determination process or flow can initiate or proceed. Some embodiments may include providing data for redirecting the user to a lockdown browser or application as part of the location determination process flow or before the location processing flow may be executed.

Some embodiments therefore permit use of a lockdown browser or application as part of a customer journey workflow, for example, a workflow or series of programmed steps that permit a transaction processor to identify the requesting user using an identity verification service, make a determination related to geographic compliance or location tampering, perform residency or financial compliance determinations, etc., for example as part of a request to access online gaming services. In some embodiments, a workflow builder or editor is used to create a customer journey workflow, for example, using a low-code development canvas into which predetermined icons representing steps on the customer journey may be linked and configured, for example requiring use of a particular identify verification service, a lockdown browser confirmation check, etc.

Such workflows may be packaged into executable applications and deployed as part of an online transaction processer functionality, for example, included in a web page, mobile gaming application, etc., such that execution of the workflow redirects the requesting user through the steps of the workflow, for example to an identity verification service, followed by a browser redirect to a financial institution, etc. In some embodiments, the lockdown browser or mobile application may perform some or all of the steps of a customer journey workflow.

Referring back to FIGS. 4 and 4A, a program 410a may be utilized to obtain and report data of client device 400 to a compliance checking service and may be used per a configuration profile set in a configuration UI. By way of example, program 410a may be a set of browser executable code embedded in a web page of a transaction processor, for example an online gaming web site. The executable code 410a may be triggered by a functional element of browser 410, for example a submit request button of a web page or the like. When triggered, program 410a may obtain data of client device 400 accessible via browser 400, for example via an operating system API. Examples of data types accessible via API to a browser via program 410a include but are not limited to data obtained from sensor APIs for client devices running various operating systems, such as iOS or Android. Examples of sensors providing data via an API include, but are not limited to, magnetometer, barometer, gravitometer, ambient light sensor, and accelerometer. In another embodiment, program 410a may also be embedded in a mobile application, in which case it is downloaded with the mobile app.

In some embodiments, program 410a obtains magnetometer data of client device 400 via an API. After reporting magnetometer data to a compliance checking service as location data (e.g., block 130 of FIG. 1), the analysis (e.g., block 140 of FIG. 1) may include processing magnetometer field values in each of the x, y and z dimensions to estimate a magnetic fingerprint which may be compared to magnetic fingerprints for the reported location. The magnetometer values reported by client device 400 may be, for example, compared against values provided by a third-party reporting service or compared directly to a community of proximal client devices providing magnetometer data, or used to derive a location, for example stored in a table associating magnetometer values with locations.

In some embodiments, similar analysis may also be performed for barometric pressure readings. By way of example, services operate a sensor network that allows barometric measurements at a known location to be converted to elevations accessible via an API. Barometric readings of client device 400 that are not consistent with the local pressure profile at a given location reported by a service may be used to filter out false readings in making a location tampering decision, e.g., as illustrated at 150 of FIG. 1. Likewise, gravity field estimations for latitude and longitude are available from sources or may be calculated using a known relationship that estimates gravity values at various latitudes and longitudes, which may be compared with accelerometer data obtained from client device 400. As with other data, barometric pressure and accelerometer data may be compared with proximal client devices that should be reporting similar sensor values.

In some embodiments, when using third party services as sources of data and/or to profile a device and return a score, program 410a allows the third-party service to share its processing status. In some embodiments, the capability and/or the status data may be provided via a communications path separate from the path(s) used for communicating with the third-party service, such as a status channel between browser 410 and a device of a compliance system.

In some embodiments, security features may be included, e.g., as part of program 4110a, such as reporting selected routing data, packet headers, routing endpoints, or the value of comparing endpoints with trusted endpoints. The report may be used alone or in some combination with other tampering indications as part of a compliance process or workflow.

In some embodiments, program 410a may obtain other data, used alone or in some combination with other data types, to form one or more fingerprints. In some embodiments, light, temperature and/or orientation data of client device 400 may be obtained, for example, via an API. In some embodiments, light data may be used to estimate time of day and may be used in combination with orientation data to determine when the device is pointing at the sun. Similarly, temperature data may be used to determine a time of day or whether the user is located indoors or outside, such as at home. A combination of light value, time, orientation, and temperature may therefore create a fingerprint used to compare with expected fingerprints for such data combinations, for example from a group of devices.

In some embodiments, program 410a may be provided as obfuscated source code, for example using data masking, opaque predicate insertion, dummy code insertion, control flow flattening, and data transformation techniques. This permits the source code of program 410a to be present on client device 400 while reducing the potential for manual intervention, for example viewing Javascript in a browser developer mode. To further obfuscate and preclude tampering with the source code, any program data, such as the location data, may be moved or transformed based on factors known only to the compliance check service. State, such as an agreed schedule, previous or other data values, the time of the request, etc., can be used to encode the data portion of program 410a in a manner that makes hacking any program data to a desired value very difficult. It should also be noted that program 410a or browser 410, or a combination thereof, may be provided to client device 400 in a different manner, such as a mobile application or component thereof.

In some embodiments, program 410a may provide an API for a requesting service that provides a checksum of the program state that can be compared to an expected value in order to ensure the code has not been tampered with. In one embodiment, a secret key is built into the program 410a and stored in an enclave of the client device 400. The key can be used by program 410a to generate a checksum value of the program 410a state, such as the machine code, the data values, and/or data addresses in a known combination. The checksum is sent via the API to the requesting service. Note that the portion of program 410a that generates the checksum may be encrypted or obfuscated in a fashion that makes that portion of the source code impossible to duplicate using conventional techniques, such as authorization tokens or decryption keys provided by the requesting service or available from a secret enclave of the client device 400. In some embodiments, the decrypted portion of code is executed in a secure mode such as provided by the operating system.

In some embodiments, in addition to detecting tampering with program 410a, other tampering detection features are included, for example tampering at the device operating system level. In some embodiments, operating system and device tampering detection may be provided in the form of a script or code included in program 410a, for example, implemented as an executable program such as JavaScript that runs in a client's browser during web page viewing and interaction. In some embodiments, the operating system and device tampering code include testing the execution of functions that are typically not allowed by the operating system (being privileged), such as accessing a protected storage on the device, accessing a remote service, allowing certain low-level Javascript functions to complete, and/or transmitting unusual header information in network packets.

Referring to FIG. 2, a user may configure a variety of sources from which to obtain comparison data, which may be used in combinations, such as community client device sensor data. This permits an embodiment to utilize crowdsourcing as a source of comparison data. As an example, a compliance checking service may have more than one client device within an area, such as city, state, or venue. Some of the proximal client devices may be legitimate or trusted, for example known or belonging to the compliance checking service and having verified sensor readings. Moreover, the general population of client devices, trusted or otherwise, associated with a given area, e.g., by Wi-Fi, Bluetooth, or cellular triangulation, GPS, etc., may be used alone or in combination with known devices to establish a population or group of client devices associated with a given area. Such group of devices may also be those of other users of the compliance service or end user applications that utilize the compliance service.

In some embodiments, the population of client device data is used to create a “ground truth” for each of the sensors, such as magnetometer, accelerometer, barometer, ambient light, etc. Statistics for the sensor data values may be computed using a grid of a predetermined size, or clustered, for example based on available sensor data reports from client devices.

The community device sensor data may be added to or associated with a geographic region, for example added to a geographical information system (GIS) table for those readings at selected latitude and longitude spacing. The statistics may include average, standard deviation, median, etc., for each sensor's data values in a grid or cluster. A reverse geographic reading may be used to retrieve the current statistics and the readings for client device, for example, in a transaction processing session, to be compared against the relevant statistics, for example, as illustrated at 140 of FIG. 1.

A location of client device may be directly estimated using a comparison with community device data. In some embodiments, an indication of anomalous sensor data from client device 400 is generated, for display or for use in a rule or workflow as part of a client device location or location tampering determination. In some embodiments, anomaly detection may be facilitated by a trained model, such as a machine learning model that performs a classification task, such as comparing client data to bins of acceptable and unacceptable values to categorize the same. In some embodiments, a machine learning model may be configured to continually evolve and improve as sensor data reports are supplied from a third-party service, community devices or crowdsourcing, or a combination of the foregoing, allowing the model to be retrained and redeployed over time.

In some embodiments, a set of environmental sensor device data therefore may be used in combination to create a fingerprint, i.e., a pre-defined set of data values, encoding or formats, indicative of devices in a location or devices of a particular type, against which a sensor data set of client device 400 is compared. For example, a fingerprint may comprise one or more of accelerometer data, barometer data, temperature data, magnetometer data, and ambient light sensor data reported by third-party service(s), community devices, or a combination thereof.

As shown in FIG. 1, a decision in block 150 and outputs in block 160 and 170, for example, a binary decision or scoring, may be applied based on discrepancy between sensor data of client device and expected readings obtained, for example, from a relevant sub-community of proximal client devices. For example, a compliance decision related to location tampering may be based on variance (e.g., standard deviation value from the mean or median) between client device and expected value(s). As described, configuration UI is used to specify rules appliable in such conditions, for example specifying that any reading more than three standard deviations away from the expect mean value are to be rated as high risk and subject to review, the result included in compliance scoring to make the transaction processor aware, etc.

The ground truth statistics may be updated with varying timing, for example depending on the reliability or variability of the proximal client devices, the nature of the reading (e.g., sensor data of a given sensor device may change more quickly than another sensor device type), the mix of device types making up the population of devices, or similar considerations. For example, statistics may be computed on a sliding window basis or other aging method to consider values changing over time of day, day of year, etc. As statistics are computed and updated, the updated values may be utilized in analyzing data of client device 400, as indicated in block 140 of FIG. 1, retraining of models, etc.

As may be appreciated, various rules making use of the result when comparing sensor data of client device 400 to a ground truth fingerprint from community client device data (both current and historical) or third-party reporting data may be implemented. For example, a thresholding process may be employed to manage any uncertainty (or certainty) in a location. For example, the location estimate may have a 3-sigma location that indicates the location is within a circle of radius 5 km. If the location is within the relevant boundaries by at least 5 km, then the estimate may be deemed acceptable. The result of using such a threshold may be used directly or fed into a rule, such as lowering a confidence score for location of client device 400 and potentially triggering a review.

A user may include a variety of data types in a compliance check. For example, the configuration UI may be used to specify an acceptable hangtime in the form of a duration of current latitude and longitude location setting, reported from program 410a. In some embodiments, program 410a provides a first location at a first time. Thereafter, program 410a provides a second location at a second time. The compliance checking service may analyze (e.g., at block 140 of FIG. 1) whether the first location and second location are the same, slightly or reasonably different, or if a change in location is unreasonable, such as having to travel at 250 mph in order to be at the two locations at the first and second times or having an unchanging location for an unreasonably long duration, depending the client device 400 type (e.g., mobile vs. desktop) and internet/communication connection type (e.g., cellular, wi-fi, fixed). As such, location tampering determination (e.g., block 150 of FIG. 1) may be influenced by a determination that hangtime or duration of location setting is inappropriate or suspect.

In some embodiments, an admin user may specify in configuration UI that given data types are expected, for example, known data types or formats to be reported by browser 410 of a given make, version, or origin, when the browser has not been tampered with. In some embodiments, signatures or fingerprints of browser data reporting sets in a standard (non-tampered browser) may be established. In such a case, analyzing may include comparing the reported data set sent via the browser with a standard, and variance flagged as suspicious or indicative of tampering.

Likewise, an admin user may specify in configuration UI that a data type, format or precision (e.g., string, integer, length, decimal places, omission or addition of data fields or portions of data, etc.) may be expected from a browser, which may be used in a comparison to the content and format of location data reported by client device. Anomalies or mismatches may be used as an indication of tampering. For example, certain browsers are known to include data portions, such as an altitude field, when used in a default setting without user adjustment or tampering. Consequently, missing data portions or inclusion of unusual data portions, such as fields, typically reported may be used as a factor in determining tampering.

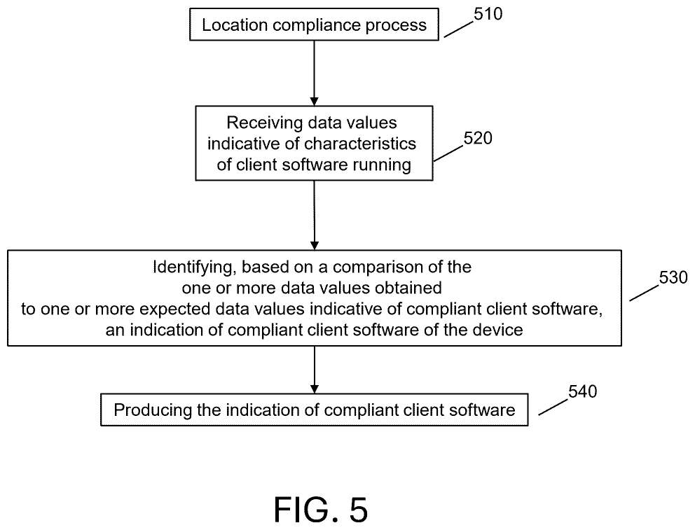

FIG. 5 illustrates an exemplary process for indication of client software compliance, according to some embodiments of the present disclosure. The embodiments may include, as part of a location compliance workflow, a check to determine code or client software compliance, e.g., if a lockdown browser or application is being used, if code of a browser has been tampered with, if a device has been rooted or jailbroken, etc. In some embodiment, the process includes a location compliance process at a server, as indicated in block 510. The process may include receiving (from a device) one or more data values indicative of one or more characteristics of client software running on the device as part of the location compliance process, as indicated in block 520. In some embodiments, the process includes identifying, based on a comparison of the one or more data values obtained to one or more expected data values indicative of compliant client software, an indication of compliant client software of the device, as illustrated in block 530. The process may include thereafter producing the indication of compliant (or non-compliant) client software, as shown in block 540.

In some embodiments, the one or more expected data values indicative of compliant client software obtained in block 520 comprise one or more of a browser type value, a browser version value, an application type value, and an application version value.

In some embodiments, the one or more expected data values indicative of compliant client software obtained in block 520 indicate that one or more features of a browser or an application of the device is inaccessible to an end user. In some embodiments, the one or more features of a browser or an application are associated with location tampering. In some embodiments, the one or more features associated with location tampering comprise one or more of a data indicative of manual location change and operating a browser in developer mode.

In some embodiments, the one or more expected data values indicative of compliant client software in block 530 indicates that one or more features of a browser or an application of the device has been accessed by an end user in a compliant manner. In some embodiments, the one or more expected data values identified indicate that the end user has accessed the one or more features using an authorization process associated with the location compliance process.

In some embodiments, the one or more data values indicative of one or more characteristics of the device obtained in block 520 are from a browser API of the device. In some embodiments, the one or more data values indicative of one or more characteristics of the device obtained in block 520 are from the client device via an API call to known first software instance running on the device. In some embodiments, the first software instance is one or more of: associated with a predetermined source, signature or secret; run in a browser in an obfuscated manner; disabled for access by a browser; accessed conditionally with an authorization token; and embedded in a mobile application of the device.

In some embodiments, a Software Development Kit (SDK) produces applications that operate as a lockdown application or a lockdown browser. In some embodiments, the SDK provides API libraries, for example in various programming languages, as well as an API client or wrapper. The SDK may include resources for developers to integrate with a location compliance process using a lockdown browser or lockdown application, for example, allowing an online gaming service or mobile gaming application to be integrated with or featured in a lockdown browser, such as presented in a gallery view or sidebar. This way, an end user wishing to access services of the online or mobile gaming application may seamlessly access it and interact with a location determination service or related workflow, such as a user identification workflow coupled to a location determination workflow.

In some embodiments, the SDK may also include a set of components for creating or integrating with workflow or process steps, e.g., a set of workflow components or related templates that developers can use to incorporate functionality of a compliance or related workflow into the application or program being developed. As one example, the SDK may define a process for user authentication and authorization, for example acceptable methods to securely authenticate users or application code and obtain access tokens. The SDK may also define compliance data submissions, for example one or more required data types, formats, etc., of submitted data required for location compliance or user identification checks.

The SDK may also define a standard format for communication, for example a format or type of compliance status retrieval, defining a query and data format for responsive status of a pending compliance check. Other types of data exchange may be defined by an SDK, such as document upload/download for handling document exchange related to location determination compliance or related processes or workflows, event notification management (such as webhook management enabling registration and handling of compliance event notifications), etc. In some cases, collections of these processes and requirements may be represented in workflow component templates, as further described herein.

Accordingly, developer tools may be included as part of an SDK, such as a command-line interface (CLI), an integrated development environment (IDE), a workflow editor, or related tools for developing, testing, configuring, and debugging. Thus, in some embodiments, a developer wanting to integrate an online or mobile gaming application with a location compliance process, customer journey, or other online transaction process, e.g., to gather the desired location and sensor data from a client device or to determine a user's current location and verify user identity, etc., may install an appropriate SDK library for a given mobile platform (e.g., a library for iOS) and be afforded with the starting components for integrating these functions into the application. The online gaming or mobile application developer uses the SDK's methods and tools, such as location determination and authentication methods or workflow components, to obtain any necessary data (e.g., an access token authenticating the user for payment, a set of client device location data for location determination, etc.) and exchange the same with a backend service contacted via appropriate APIs as per the SDK.

In some embodiments, data exchange may be included with the SDK in which, the online or mobile gaming application collects the specified data, e.g., location data, user identification information, etc., and uses one or more APIs of the SDK to submit such data to one or more remote services, such as a user authentication service, a location determination backend, etc. In some embodiments, data exchange messages may be provided, for example once the user or location compliance check is initiated, in-progress, or completed, the online or mobile gaming application obtains a status message, e.g., a result. In certain cases, for example, for error handling, the backend service may dynamically insert data based on the status, such as displayable data describing an error encountered during the process, such as a lockdown browser data type expected was not returned. In this fashion, the SDK provides error definitions such as codes and messages that the online or mobile gaming application can use to inform the end user of the client device regarding the status of the compliance process or workflow, remedies, etc. In some embodiments, the SDK may provide jurisdiction-specific error codes, status message content, etc., for example customized to the backend service or gaming service applicable to the context.

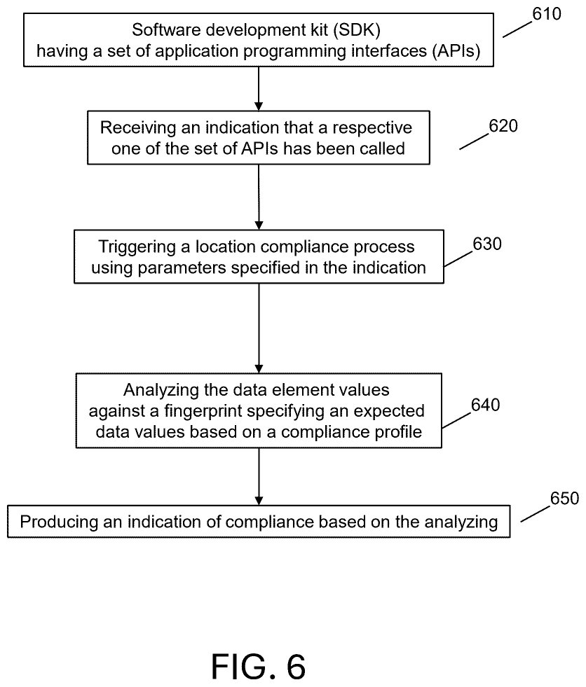

FIG. 6 shows an exemplary process for indication of client software compliance using an SDK, according to some embodiments of the present disclosure. The SDK may include a set of APIs, indicated in block 610. In some embodiments, the process includes receiving, from one or more client devices, an indication that a respective one of the set of APIs has been called by a user of a first application configurable to run on the one or more client devices, indicated in block 620. In some embodiments, the SDK access client-device APIs to get location, sensor data, etc.

Responsive to the indication in block 620, the process may include triggering a location compliance process using one or more parameters specified in the indication, wherein at least one parameter requires an API response including data element values, indicated in block 630. The process may include analyzing, using a set of one or more processors, the data element values against a fingerprint specifying one or more expected data values based on a compliance profile, as indicated in block 640. In block 650, the process then produces an indication of compliance based on the analyzing.

In some embodiments, the one or more parameters comprise environmental data. In some embodiments, the data element values comprise predetermined data types derived from one or more sensors of the one or more client devices. In some embodiments, the data element values comprise data indicative of location of the one or more client devices. In an embodiment, the location is one or more of a geographic location and a relative location with respect to an expected location. In some embodiments, the data element values comprise a lockdown browser indication.

In some embodiments, the set of one or more APIs comprise a first API specifying a particular set of the one or more parameters required for a first location compliance process. In some embodiments, each of the set of one or more APIs defines a different set of the parameters required for different location compliance processes. In some embodiments, the SDK includes different subsets of the set of one or more APIs that are selectable for use by the one or more client devices for respective location compliance processes. In some embodiments, the process verifies that the first application conforms to the compliance profile.

In some embodiments, the process publishes the first application to make it available for use by the one or more client devices. In some embodiments, the set of one or more APIs specify one or more browser API calls for collecting one or more predefined data types as the one or more data element values via the one or more browser API calls.

Referring back to FIGS. 4 and 4A, in some embodiments for online or mobile gaming, applications 420a-420n (e.g., developed according to an SDK) may be featured in an application store, gallery, or sidebar 420, for example, within a lockdown browser 410. In some embodiments, within lockdown browser 410, a centralized hub in the form of sidebar 420 displaying compliant online or mobile gaming applications 420a-420n directly integrated into the interface of lockdown browser 400. Displaying applications 420a-420n within lockdown browser 410 integrates the applications, or direct access thereto, within the same view, keeping end users constantly updated on the latest developments and available gaming applications that are compliant, offering a streamlined experience. In some embodiments, end users can find curated and compliant gaming applications 420a-420n within the gallery or sidebar 420, offering a single, easily accessible location. This eliminates the need to navigate multiple websites or platforms to identify and select a compliant online or mobile gaming application.

In some embodiments, online or mobile gaming applications 420a-420n may be featured in a game platform or application store in addition to or in lieu of integrating in a sidebar 420 of lockdown browser 410. In some embodiments, the game platform or application store may be separate and distinct from any given lockdown browser. By way of example to get a game featured within a game platform or application store, developers publish creations to the game platform or application store for review. In a game platform or application store, other users can discover and play browser-based or mobile games that are compliant with one or more compliance processes, for example, a location compliance process for a given jurisdiction. The game platform or application store may sort or filter available games based on compatibility or compliance with jurisdictional requirements, lockdown browsers, location determination processes, or other workflows and requirements. The game platform or application store therefore makes compliant application discovery and distribution a technically simplified experience.

As shown in FIG. 4, in some embodiments, some online or mobile games 420a-420n may be directly embedded within sidebar 420 of lockdown browser 410, which may be a view of an application store or gaming platform, for example allowing games to be selectable in side panel 420. Once selected, referring to FIG. 4A, an online gaming application, e.g., 420a, opens and expands in a window or tab 430 within lockdown browser 410 for play. In some embodiments, where a game platform or application store is used, the selection of an application icon, e.g., for online or mobile games 420a-420n, may link to or launch, in a web browser, mobile application, or application store, the game application or option to download the same.

As described above, some embodiments may facilitate use of a lockdown browser in connection with various predetermined applications, ensuring the applications are used with a compliant browser.

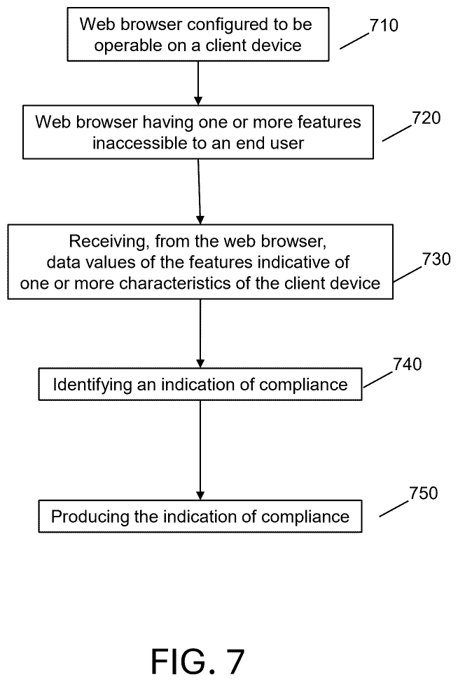

FIG. 7 illustrates an exemplary process for indication of client browser compliance, according to some embodiments of the present disclosure. The browser also uses or accesses client-device APIs, like the SDK can do. For example, to access location and other sensor data. As shown in block 710, a web browser is configured to be operable on a client device. The web browser may have one or more features set as at least temporarily inaccessible to an end user, wherein the one or more features are associated with a location report, as indicated in block 720. For example, in an embodiment the web browser with certain features inaccessible is a lockdown browser. In block 730, the process, as part of a location compliance process, obtains from the web browser, one or more data values of the one or more features indicative of one or more characteristics of the client device.

The one or more data values of the one or more features may include data indicative of a disabled developer mode, a lockdown browser indication, a browser version indication, etc. In block 740, an indication of compliance is identified based on a comparison of the one or more data values obtained to one or more expected data values. By way of example, the expected data value may be a required lockdown browser identification, etc. In block 750, the indication of compliance, e.g., permitting the browser to access a service protected by location verification procedure is produced.

### Workflows

FIG. 8 illustrates an example workflow editor device according to some embodiments of the present disclosure. As shown, one or more workflows may be provided to establish location compliance routines, for example as part of an online or mobile gaming application. In some embodiments, a workflow may form more complete customer journeys, for example including steps in addition to location determination, such as user authentication, financial services for funding accounts in an application, and the like.

As shown in FIG. 8, a low-code workflow editor having a canvas area 810 designed for drag-and-drop creation of business process logic that forms the basis of a workflow. The canvas area 810 is where users can construct complex workflows without extensive coding knowledge. In an embodiment, a workflow editor provides an area 820 having pre-built components 820a-820n, representing various actions that may be used in a workflow, such as data manipulation, API calls, conditional logic, and user interactions. The various actions may be defined in an SDK as described herein, whereas the workflow editor may be provided as a tool included in the SDK or associated therewith.

Users can drag these components 820a-820n onto canvas 810 and connect them with visual connectors as depicted for components 820b, 820c, 820d, and 820e. The components 820b, 820c, 820d, and 820e and connectors define the data and its flow for the workflow execution. Each component 820a-820n may be configurable through definable properties, allowing users to specify parameters and settings. For example, a workflow editor may include features for defining variables, creating loops, and handling errors, enabling the creation of workflows that are compliant with a set of backend services, such as a location determination service, a user authentication service, financial services, etc.

In some embodiments, each component of the set of components 820a-820n may be associated with a type, for example location compliance, financial, user authentication, etc. In each type, a set of metadata may be provided to configure the components of the type per requirements of associated back-end services. By way of example, a location compliance type of component may be provided in which a user selecting the component for addition to canvas 810 is supplied with a UI or UI part that displays selectable parameters that are predetermined based on a location compliance service. For example, the UI shown in FIG. 2 or FIG. 3, or similar UI, may be displayed in association with a location compliance workflow node selection, permitting the user to select from among location compliance settings or configurations, parameterizing the selected location compliance workflow node.

In some embodiments, one or more of the parameter values, e.g., requirement for a particular lockdown browser to be utilized, may be set in a template to assist the user in selecting a workflow node and its configuration that is compatible or compliant with a given type of location compliance. Likewise, other workflow components may be similarly associated with configuration templates. Further, sets of components, e.g., for a particular customer journey or an online transaction processing workflow, may be associated with one another and with configuration templates to assist the user in forming the respective workflow in a streamlined manner. For example, a user may search within the workflow editor based on customer journey type or an online transaction processing workflow type, e.g., new user for gaming application x in jurisdiction x, and be provided with a partially or fully configured workflow based on the templates.

In some embodiments, validation and debugging tools may be provided to help users identify and resolve issues during the workflow design process, ensuring that the workflow functions as intended. For example, built in checking functionality of workflow editor may preclude a user from constructing a workflow that directs a user to a gaming service API prior to performing a location determination. Likewise, a workflow editor may provide an error message if a user attempts to construct a workflow that transitions a user to a financial funding API without first performing a required authentication. The editor may output operable code that may be added to a larger project or package, for example an online or mobile gaming application. In some embodiments, a user may publish or export the workflow, e.g., using interface element 830, which makes the workflow available to a set of users, for example associated with the user working in workflow editor.

By way of example, consider a customer journey workflow for requesting a service in connection with an online or mobile gaming application. Referring to FIG. 8, a developer may design a workflow using a workflow editor by placing an initial component 820b as a user beginning by submitting a service request through a web or mobile interface. Component 820b includes functionality to capture data triggering the workflow, such as receiving a request for an online gaming service. Next, a component 820c directs the user to an authentication system, such as an external authentication system that is federated with the online or mobile gaming application. Upon successful authentication, as judged by conditional logic component 820d, the user is redirected to a next step in the workflow, for example component 820e representing a component that operates after a user has been authenticated, such as a location data collection step, a financial transaction step, etc. Component 820e thus uses an authenticated user's data to proceed to one or more next steps of the workflow, represented by additional components (not shown for brevity).

In some embodiments, components 820a-820n may be predetermined functional code modules that can be dragged into place and wired together to assist a developer in creating a customer journey for an online or mobile gaming application, for example including user authentication, financial transaction processing, and location determination steps. The components of the workflow, e.g., components 820b-820e, guide the user along a process that makes the online or mobile gaming application compliant with relevant requirements, e.g., per jurisdiction, device configuration or any other requirements, which may be defined by components of an SDK. In some embodiments, the entire workflow is constructed by dragging and dropping components 820a-820n onto canvas 810, connecting them in the desired sequence, and configuring their properties to match the specific requirements of the service request process.

FIG. 9 illustrates an exemplary process for a workflow editor application, according to some embodiments of the present disclosure. The workflow editor application is configured to be operable on a client device, as indicated in block 910. The process includes, within the workflow editor application, incorporating a set of predetermined workflow components, as shown in block 920. The process proceeds by receiving, from a user, an indication of a first workflow type and identifying, based the first workflow type, an editable workflow template that includes a plurality of components and at least one location compliance process component, as indicated in blocks 930 and 940, respectively. In some embodiments, the process includes providing, in the workflow editor application, the editable workflow template including at least one location compliance process component having one or more values preconfigured based on the first workflow type, indicated in block 950. In some embodiments, the editable workflow template comprises one or more customer journey workflow components. In some embodiments, the customer journey workflow components comprise a user authorization component.

In some embodiments, the workflow editor interacts with the workflow components to form a compliant workflow more user friendly and efficient. For example, the workflow editor receives, from the user, an interaction with the at least one location compliance process component; and provides, in the workflow editor application, a UI displaying a set of configurable data types defining at least one location compliance process. As described herein, this may include presenting a UI similar to FIG. 2 or FIG. 3 for selecting or defining data of a workflow component to ensure it operates per requirements of a protocol, such as a location determination protocol of a back-end service.

In some embodiments, when a user is done configuring the workflow, the user may publish or export the operational workflow code as a file or file package. In some embodiments, a process as illustrated in FIG. 9 may include receiving, from the user, a request to make the workflow accessible to one or more other users and outputting, from the workflow editor application, a workflow executable file that may be invoked as a service. In some embodiments, this may include providing the workflow as a downloaded file for import into another system. This may also include providing the workflow in a cloud platform as a callable service or endpoint.

In some embodiments, the process receives, from the user, a request to make a first component of the workflow editable by one or more other users, where a first parameter in the first component can be updated. The first parameter may include one of a restricted set of allowed values that can be input. For example, a user may be permitted to change a flow element's parameters, for instance, select among integer values impacting how stringent a compliance process step is evaluated but may be required to choose from allowed values. For example, requiring one of a set of allowed values requires the user to choose among acceptable alternatives. In some embodiments, an authorization is required to perform the update, such as to update a flow element or component to one of the allowed set of values.

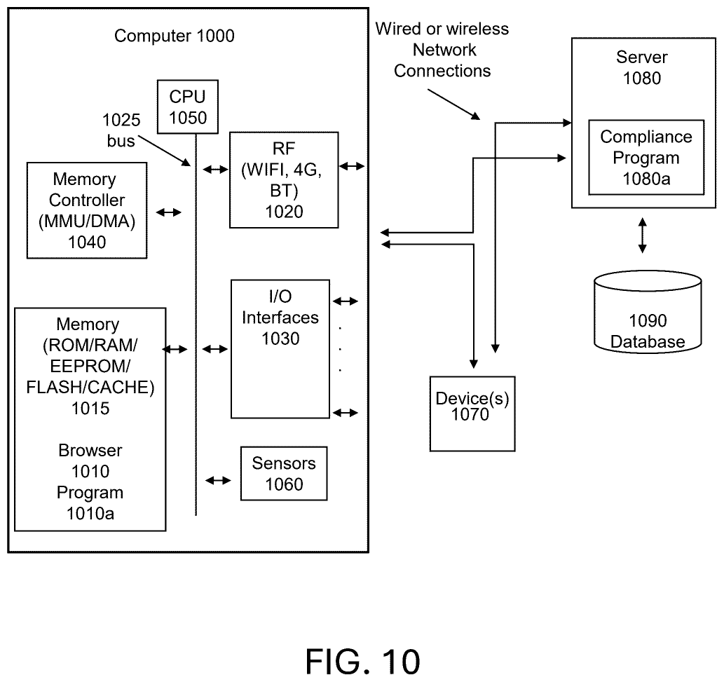

FIG. 10 depicts an exemplary system, according to some embodiments of the present disclosure. It will be readily understood that certain embodiments can be implemented using any of a wide variety of devices or combinations of devices. As shown, a computing device (computer) 1000, for example a client device such as client device 400 in FIG. 4, a server 1080 (which may include some, all of, or different components of computer 1000) of a compliance checking service that operates a process, or parts thereof, as shown in FIG. 1. It is also readily understood that location validation may be used in embodiments that combine other attributes of the device user, such as ID validation, age, residence, financial, etc., from known services in the art in order to provide a more complete, one-stop service for a transaction processor.

Computer 1000 executes program instructions or code configured to obtain, store, communicate, and process location data (e.g., sensor device data as described herein) and perform other functionality of the embodiments. Components of computer 1000 may include, but are not limited to, a processing unit 1050, which may take a variety of forms such as a central processing unit (CPU), a graphics processing unit (GPU), a combination of the foregoing, etc., a system memory controller 1040 and memory 1015, and a system bus 1025 that couples various system components including the system memory 1015 to the processing unit 1050. The computer 1000 may include or have access to a variety of non-transitory computer readable media. System memory 1015 also includes an operating system, application programs, other program modules, and program data.

For example, system memory 1015 may include application programs such as browser software 1010 and program 1010a, such as a program for performing some or all of the functions explained in connection with FIG. 4. Data may be transmitted by wired or wireless communication, e.g., to or from computer 1000 and another computing device, e.g., a remote device or system 1080, such as a cloud server that offers compliance checking service via program 1080a and stores data in a database 1090, a community of devices 1070, etc. Computer 1000 may utilize wireless communication devices, such as radio frequency (RF) devices 1020, which may provide sensor data useful in forming location data. Further, sensors 1060 may include accelerometer, magnetometer, gravitometer, barometer, ambient light sensor, and similar devices that provide data useful in assessing or validating location data, as described herein.

A user can interface with (for example, enter commands and information) the computer 1000 through input devices such as a touch screen, keypad, etc. A monitor or other type of display screen or device can also be connected to the system bus 1025 via an interface, such as interface 1030. The computer 1000 may operate in a networked or distributed environment using logical connections to one or more other remote computers or databases. The logical connections may include a network, such as local area network (LAN) or a wide area network (WAN) but may also include other networks/buses.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims and drawings.

What is claimed is:

1. A method, executed by one or more processors, for authenticating a location of a device, the method comprising:
obtaining, from a client device, location data;
configuring a location compliance profile incorporating a combination of one or more environmental data types;
forming a fingerprint combining one or more expected location data values based on the location compliance profile;
analyzing the location data against the fingerprint specifying one or more expected location data values based on the location compliance profile;
identifying an indication of location tampering based on the analyzing; and
indicating, based on the analyzing, that the client device location is confirmed or not confirmed.

2. The method of claim 1, wherein the one or more environmental data types comprise one or more of:
sensor data from the client device;
reference sensor data for the client device, wherein the reference sensor data is predetermined and stored in a database;
community device sensor data; and
external reporting data.

3. The method of claim 1, wherein the location compliance profile specifies an expected set of data value types and a set of data value types that are not expected; and the analyzing comprises determining that the location data indicates one or more of:
the expected set of data value types is missing; and
one or more of the set of data value types that are not expected is present.

4. The method of claim 1, wherein the location compliance profile specifies an acceptable data format or a type of location data; and
the analyzing comprises determining that a first data format or a first data type of the location data is not acceptable.

5. The method of claim 1, wherein the location compliance profile specifies one or more of a browser mode setting, an acceptable location hangtime, and an acceptable location change.

6. The method of claim 1, wherein the expected location data values comprise one or more of ambient light sensor data, magnetometer data, barometer data, and accelerometer data.

7. The method of claim 1, wherein the location data are obtained from a browser application programming interface (API) of the client device.

8. The method of claim 1, wherein the fingerprint of one or more expected location data values is statistical data derived from one or more other devices of predetermined geographic location.

9. The method of claim 8, wherein the data of the one or more other devices of predetermined geographic location is stored in association with a grid location or a cluster associated with the predetermined geographic location.

10. The method of claim 9, further comprising producing a reverse geographic reading by:
retrieving current descriptive data of the one or more other devices of predetermined geographic location; and comparing the current descriptive data to the location data of the client device.

11. A system for authenticating a location of a device comprising:
one or more processors; and
a non-transitory storage medium comprising code executable by the one or more processors, wherein the one or more processors are configured to
obtain, from a client device, location data;
configure a location compliance profile specifying a combination of one or more environmental data types;
form a fingerprint combining one or more expected location data values based on the location compliance profile;
analyze the location data against the fingerprint specifying one or more expected location data values based on the location compliance profile;
identify an indication of location tampering based on the analyzing; and
indicate, based on the analyzing, that the client device location is confirmed or not confirmed.

12. The system of claim 11, wherein the one or more environmental data types comprise one or more of sensor data from the client device; reference sensor data for the client device, wherein the reference sensor data is predetermined and stored in a database; community device sensor data; and external reporting data.

13. The system of claim 11, wherein the location compliance profile specifies one or more of an expected set of data value types and a set of data value types that are not expected; and the one or more processors analyze the location data by determining that the location data indicates one or more of: one or more of the expected set of data value types is missing; and one or more of the set of data value types that are not expected is present.

14. The system of claim 11, wherein the location compliance profile specifies an acceptable data format or a type of location data; and
the one or more processors analyze the location data by determining that a first data format or a first data type of the location data is not acceptable.

15. The system of claim 11, wherein the location compliance profile specifies one or more of: a browser mode setting, an acceptable location hangtime, and an acceptable location change.

16. The system of claim 11, wherein the expected location data values comprise one or more of ambient light sensor data, magnetometer data, barometer data, and accelerometer data.

17. The system of claim 11, wherein the location data are obtained from a browser application programming interface (API) of the client device.

18. The system of claim 11, wherein the fingerprint of one or more expected location data values is statistical data derived from one or more other devices of predetermined geographic location.

19. The system of claim 18, wherein the data of the one or more other devices of predetermined geographic location is stored in association with a grid location or a cluster associated with the predetermined geographic location.

20. A non-transitory storage medium comprising executable code, when executed by one or more processor, the executable code performs a method for authenticating a location of a device, the method comprising:
obtaining, from a client device, location data;
configuring a location compliance profile incorporating a combination of one or more environmental data types;
forming a fingerprint combining one or more expected location data values based on the location compliance profile;
analyzing the location data against the fingerprint specifying one or more expected location data values based on the location compliance profile;
identifying an indication of location tampering based on the analyzing; and
indicating, based on the analyzing, that the client device location is confirmed or not confirmed.
